(19) United States
(12) Patent Application Publication
(10) Pub. No.: US 2023/0312398 A1
(43) Pub. Date: Oct. 5, 2023

(54) GROUND COAT ENAMEL COMPOSITION, GROUND COAT ENAMEL LAYER, PRODUCTS CONTAINING SAME AND METHODS FOR PRODUCING SAME

(71) Applicant: PFAUDLER GMBH, Waghaeusel (DE)

(72) Inventor: Günter Wilhelm SCHÄFER, Westhofen (DE)

(73) Assignee: PFAUDLER GMBH, Waghaeusel (DE)

(21) Appl. No.: 18/022,821

(22) PCT Filed: Aug. 4, 2021
(86) PCT No.: PCT/EP2021/071790

§ 371 Date: Feb. 23, 2023

(30) Foreign Application Priority Data
Aug. 25, 2020 (DE) 10 2020 122 188.6

(51) Int. Cl. C03C 8/06; C03C 4/20; C03C 3/118; C03C 3/091; C23D 5/00; C23D 7/00

(52) U.S. Cl. CPC C03C 8/06; C03C 4/20; C03C 3/118; C03C 3/091; C23D 5/00; C23D 7/00; C03C 2207/04; C03C 2204/00

(57) ABSTRACT

A ground coat enamel composition for production of an adhesion promoter layer between steel and at least one cover coat enamel for production of an enamel-based coating that is highly corrosion-resistant with respect to mechanical, thermal and chemical effects. The ground coat enamel composition includes boron oxide (B₂O₃) and alkali metal oxide(s), especially Li₂O, Na₂O and/or K₂O, in percentage proportions by weight: a first main constituent, SiO₂ from 35-70%, preferably 40-65%, and, as a second main constituent, from Fe₂O₃ 5-28%, preferably in the range from 7-23% and particularly 8%-15% by weight. Also disclosed is a ground coat enamel layer produced from such a ground coat enamel composition. A highly corrosion-resistant article having such a ground coat enamel layer. A method for producing such a ground coat enamel layer and also a method for producing a highly corrosion-resistant article using such a ground coat enamel composition.

The invention relates to a ground coat enamel composition in accordance with the preamble to patent claim 1, to a ground coat enamel layer produced from such a ground coat enamel composition in accordance with the preamble to patent claim 5, to an article that is highly corrosion-resistant with respect to mechanical, thermal and chemical effects and having such a ground coat enamel layer in accordance with the preamble to patent claim 13, to a method for producing such a ground coat enamel layer in accordance with the preamble to patent claim 15, to a method for producing a highly corrosion-resistant article in accordance with the preamble to patent claim 16 and to the use of a ground coat enamel composition for producing a highly corrosion-resistant article in accordance with the preamble to patent claim 17.

Ground coat enamel compositions have been known for some time and are essential for the production of highly corrosion-resistant articles, which typically have a highly corrosion-resistant surface formed from a cover coat enamel. The ground coat enamel composition here serves to produce a ground coat enamel layer, which forms a kind of adhesion promoter layer between the steel of the base body of the highly corrosion-resistant article to be produced and the cover coat enamel layer that provides the article with its high corrosion resistance. The cover coat enamel layer has firstly an extremely smooth and also moreover a mechanically extremely stable and chemically inert surface. The combination of the steel of the base body, the ground coat enamel layer and the cover coat enamel layer forms a steel-enamel composite material.

Steel-enamel composite materials of this kind are today firmly established in the chemical and pharmaceuticals industry in the management of processes using highly corrosive media or in sterile high-purity applications. Whenever, for example, it is a matter of a particular product purity, when formation of coats is to be avoided or when required hygiene method steps necessitate sterilization, for example, the extremely smooth, stable and chemically inert surface of a chemical enamel (as the aforementioned steel-enamel composite materials may also be referred to) provide optimal conditions.

An enamel is a glassy, solidified silicatic melt which is fused onto a metallic carrier material. Extremely high requirements in terms of surface quality of the sheet metals used and in terms of the chemical composition thereof are placed on the carrier material, usually steel sheet, of the base body. For instance, as carrier material for the base bodies boilerplates are in particular used nowadays. For reasons of good adhesion of the enamel to the boilerplate, or the steel sheet, the maximum permitted carbon content in the sheet metals in accordance with the current standard is not more than 0.16% by weight. The reason for this is that enamel must undergo a chemical reaction with the steel for the enamel layer to be able to chemically bond to the steel. This bonding of the enamel layer with the steel takes place in the context of a chemical reaction in the course of which the silicatic melt bonds to the steel but in the course of which also, as side reaction, carbon oxide gases form from the carbon present in the steel and from the oxygen originating from the silicatic melt, these gases remaining dissolved in the enamel as bubbles and having a lasting adverse effect on the properties of the enamel applied to the steel.

Since a good adhesion of the enamel applied to the steel is essential, it is typical practice, as mentioned above, to first apply a ground coat enamel layer to the steel. In order to improve the adhesion of this ground coat enamel layer to the steel, what are known as adherence oxides have been used in past ground coat enamel compositions, which were admixed with the past ground coat enamel compositions. These are conventionally nickel oxide, cobalt oxide and/or manganese oxide. Since nickel oxide is a toxic substance, and in order to avoid the toxic properties of nickel oxide, there have in the past been attempts to find substitute oxides. More recent developments therefore give preference in this respect to the use as adherence oxides of rare earth oxides and also oxides of molybdenum and tungsten, in order to improve a chemical reaction of the ground coat enamel with the steel surface and optimize the adhesion of the ground coat enamel to the steel surface. In addition, the cobalt oxide acting as adherence oxide should if possible also be substituted, since, further to the health hazards stemming from cobalt oxide, the production, or mining, of cobalt oxide also takes place under socially and environmentally critical conditions. Cobalt is incidentally also currently indispensable for electromobility, which means that not only is cobalt expensive but there are also already signs of scarcity of this raw material.

In all enameling methods that are known to date from the prior art and in commercial use, there is during the actual enameling process, i.e. during the production of a ground coat enamel layer on the steel base body, at temperatures of between 800° C.-960° C., a chemical redox reaction between the enamel melt, or glass melt, which is more liquid at these temperatures, and the underlying steel substrate. On account of their chemically defined, more noble character compared to iron, the above-described metal ions of the oxides of cobalt (Co), nickel (Ni), manganese (Mn), molybdenum (Mo), tungsten (W) and/or of the rare earth metals are reduced at these elevated temperatures to their metallic state and form an alloy with the iron (Fe) of the steel surface. At the same time, conversely, oxidation of metallic iron (Fe) to Fe²⁺ and Fe³⁺ takes place. In addition, the carbon used, or present, in the steel is also oxidized to carbon monoxide (CO), but mainly to carbon dioxide (CO₂).

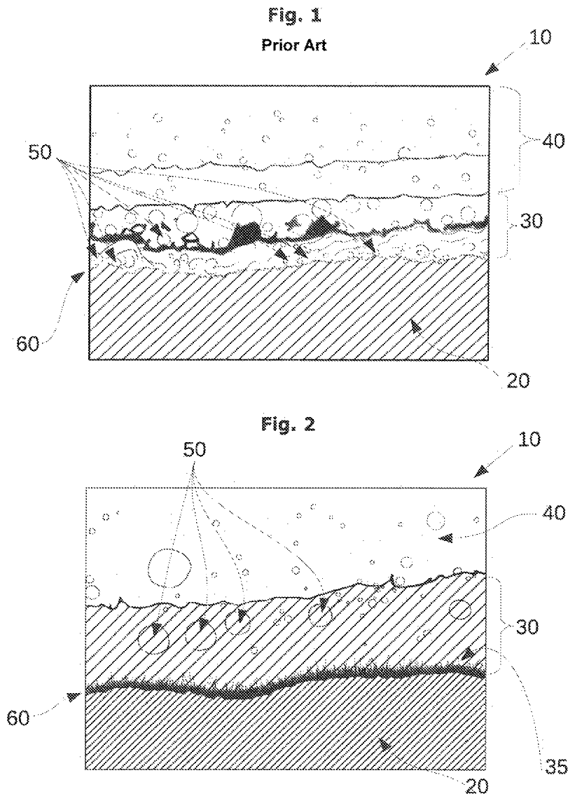

The latter in particular, i.e. the oxidation of carbon present in the steel with the oxygen originating in particular from the adherence oxides of the ground coat enamel composition that inevitably takes place in the course of the enameling process, is extremely disadvantageous, since the carbon dioxide in particular leads to the formation of gas bubbles and a positively large-volume bubble structure within the ground coat enamel and in particular along the steel-enamel interfacial layer, as is illustrated in the sectional view of a steel sheet coated with a ground coat enamel layer and a plurality of cover coat enamel layers shown in FIG. 1. Both the bubble formation per se and the bubbles distributed within the ground coat enamel disrupt a mechanical homogeneity and hence also a mechanical stability of the finished enamel layer after enameling. A practically reasonable and in particular also feasible possibility for avoiding such bubble formation therefore consists in limiting the carbon content of the sheet metal to be used in advance.

A further disadvantage of the presence of adherence oxide ions in the ground coat enamel composition consists in that a reduction of the metals of the adherence oxide ions to their metallic state and their subsequent formation of an alloy with the iron of the steel base body on the one hand proceeds as an exothermic process and leads to an uncontrollable alloying of the steel surface, but on the other hand is necessary in past conventional ground coat enamel compositions for a chemical bonding of the enamel layer with the steel.

A further difficulty with past conventional ground coat enamel compositions for achieving a uniform and well-adhering coating on a steel surface of an article consists in that when applying these past ground coat enamel compositions it is highly difficult if not impossible to obtain a completely uniform layer application of a ground coat enamel composition slip on the steel surface of the article on account of complex geometries of containers and especially turbines and stirrers. However, for a completely consistently and uniformly proceeding adhesion reaction of the ground coat enamel on the steel surface it would be necessary for the steel surface of the article to be coated with the ground coat enamel composition as consistently and uniformly as possible. For instance, the differing geometries and highly fluctuating steel thicknesses of up to a tolerance of 200% within a component in most cases result in it being standard in practice for a first application of a ground coat enamel composition slip on the steel surface of the article to be defective and to lead only to an inadequate defective ground coat enamel layer, and therefore for a second application of the ground coat enamel composition slip on the first ground coat enamel layer to be necessary. A disadvantage resulting from this in turn is that the ground coat enamel does not completely uniformly adhere to the steel surface of the article, in particular as well since the second ground coat enamel composition application on the defective first layer of ground coat enamel leads in turn to the adhesion reaction between the enamel layer and the steel proceeding unevenly.

A further disadvantage of the aforementioned alloy formation of the metals of the adherence oxides with the steel surface of the article to be coated is also that such alloying of the steel surface generally takes place non-uniformly, which then within the interfacial layer at the steel surface leads locally to electrochemical element formation with electric currents which further amplify the inequality of the alloying of the steel surface. Such an “overreaction”, in which a “stainless steel surface” forms over the steel surface, reduces the generated adhesion of the ground coat enamel layer on the steel surface with the result that in the worst case the enamel layer may spontaneously become locally detached.

During a complete enameling process for producing a highly corrosion-resistant article, firstly, as previously mentioned and as required, one to two ground coat enamel layers are applied to the metallic carrier material. The object of the ground coat enamel layers is that of creating adhesion between the chemically resistant cover coat enamel layers and the carrier material, i.e. the steel of the base body. The ground coat enamel has a comparatively low chemical resistance compared to the cover coat enamel and should therefore generally be applied only as a thin adhesion promoter layer. However, as previously mentioned, it is necessary to apply a second and possibly third ground coat enamel layer if the first ground coat enamel layer is not sufficiently homogeneous and hence requires one or more further ground coat enamel layers. The layer thicknesses for the ground coat enamel that can be achieved by repeated spraying and firing of the article coated with the ground coat enamel composition vary in the prior art to date generally between 0.2 and 0.9 mm, with the layer thicknesses of the overall ground coat enamel frequently being thicker and lying within the range from 0.3 to 0.6 mm.

However, a problem with such large total layer thicknesses of a ground coat enamel layer is that the total layer thickness of all enamel layer thicknesses, that is to say both of the ground coat enamel and of the cover coat enamel, for a commercial enameling is set down in DIN/ISO standards. The total layer thicknesses of ground coat and cover coat enamel together that are permitted according to these standards are in the range between 1 mm and 2.2 mm, with allowed tolerances of 0.2 mm above or below.

Since, however, only the cover coat enamel layer has the properties of good enameling that are required for the desired corrosion resistance, this layer should be as thick as possible and the ground coat enamel layer in contrast should be as thin as possible. In combination with the frequently required repeated ground coat enamel coating, this in turn has the consequence that only a few tenths of a millimeter still remain for the layer thickness of the cover coat enamel layer that is required for the chemical and also mechanical corrosion resistance, with the result that a DIN/ISO standard 28721-1-compliant enamel coating of an article is smaller than desired, which in turn has a negative impact on the lifetime of the article and often requires premature reconditioning of the enamel coating of the steel base body.

Proceeding from these problems known from the prior art, it is an object of the invention to provide a ground coat enamel composition which makes it possible to provide, while avoiding and/or reducing the abovementioned problems, a ground coat enamel layer for production of a highly corrosion-resistant article and also a method for producing such a ground coat enamel layer and additionally a method for producing a highly corrosion-resistant article using such a ground coat enamel composition, and furthermore also the use of such a ground coat enamel composition for producing a highly corrosion-resistant article.

This object is achieved by a ground coat enamel composition as claimed in patent claim 1, by a ground coat enamel layer produced from such a ground coat enamel composition as claimed in patent claim 5, by a highly corrosion-resistant article having such a ground coat enamel layer as claimed in patent claim 13 and also by a method for producing such a ground coat enamel layer as claimed in patent claim 15, a method for producing a highly corrosion-resistant article using such a ground coat enamel composition as claimed in patent claim 16 and by the use of such a ground coat enamel composition for producing a highly corrosion-resistant article as claimed in patent claim 17.

In particular, the object of the invention is achieved by a ground coat enamel composition for production of an adhesion promoter layer between steel and at least one cover coat enamel for production of an enamel-based coating that is highly corrosion-resistant with respect to mechanical, thermal and chemical effects, wherein the ground coat enamel composition includes boron oxide (B²O₃) and alkali metal oxide(s), especially lithium oxide (Li₂O), sodium oxide (Na₂O) and/or potassium oxide (K₂O), in proportions by weight in accordance with the following table

| | | preferably | particularly |
|---|---|---|---|
| | [% by | [% by | preferably [% |
| Constituent | weight] | weight] | by weight] |
| B₂O₃ | 4-22 | 4.5-21.5 | 5-20 |
| Sum total of | 7.8-22.5 | 8.5-21.5 | 10-20 |
| alkali metal | | | |
| oxide(s) | | | |

and, as a first main constituent, SiO₂ with a percentage proportion by weight in the range from 35% by weight to 70% by weight, preferably in the range from 40% by weight to 65% by weight, and, as a second main constituent, Fe₂O₃ with a percentage proportion by weight in the range from 5% by weight to 28% by weight, preferably in the range from 7% by weight to 23% by weight and particularly preferably in the range from 8% by weight to 15% by weight.

An essential point of the invention consists in that comproportionation of iron(III) and iron(0) to iron(II) takes place as a result of the presence of iron(III) oxide in the ground coat enamel composition during an application to the steel surface of the base body together with the metallic iron from the steel surface of the base body at elevated temperature, which is required to produce a ground coat enamel layer. The iron(II) subsequently further reacts with silicon dioxide, likewise present in the ground coat enamel composition according to the invention, to give iron silicate. Since this reaction of iron(III) oxide with elemental metallic iron takes place directly at the interface of steel and enamel, i.e. ground coat enamel, a very good and direct bond of the iron silicate with the steel surface results. Since this reaction takes place during the enameling process at elevated temperatures over the entire surface of the steel base body which has been coated with the ground coat enamel composition according to the invention, a continuous iron silicate layer arises over the entire surface of the steel base body, by means of which the surface of the steel base body is shielded from external effects so that in particular an ingress of oxygen, which originated from past ground coat enamel compositions, to the carbon present in the steel and hence also the formation of carbon oxide, i.e. carbon monoxide and carbon dioxide, is effectively suppressed. An essential advantage of the ground coat enamel composition according to the invention therefore consists in that bubble formation in the ground coat enamel layer, which according to the prior art continued in principle on each heating of the article and hence also of the ground coat enamel layer and of the steel, is no longer to be feared when coating the surface of the steel base body with the ground coat enamel composition according to the invention, which results in a considerable improvement in the chemical and mechanical corrosion resistance of an article coated with the ground coat enamel composition according to the invention.

According to one embodiment of the invention, the ground coat enamel composition according to the invention, in addition to the two main constituents silicon dioxide and iron(III) oxide and also further the aforementioned boron oxide (B₂O₃) and alkali metal oxide(s), especially lithium oxide (Li₂O), sodium oxide (Na₂O) and/or potassium oxide (K₂O), if desired also includes aluminum oxide (Al₂O₃) and alkaline earth metal oxide(s), especially calcium oxide, in proportions by weight in accordance with the following table:

| | | preferably | particularly |
|---|---|---|---|
| | [% by | [% by | preferably [% |
| Constituent | weight] | weight] | by weight] |
| Al₂O₃ | 1.5-13 | 2-12 | 3-10 |
| Sum total of | 0.25-6 | 0.4-5 | 0.55-4.4 |
| alkaline | | | |
| earth metal | | | |
| oxide(s) | | | |

Furthermore, the ground coat enamel composition can further include at least one substance, especially zinc oxide (ZnO), titanium dioxide (TiO₂) and/or calcium fluoride (CaF₂). The latter substances can advantageously be used for controlling a rheology of a melt of the ground coat enamel composition, with the proportions by weight of the substances given in the following table having proven to be advantageous:

| | | preferably | particularly |
|---|---|---|---|
| | [% by | [% by | preferably [% |
| Constituent | weight] | weight] | by weight] |
| Sum total of | 0-14 | 0.001-12 | 0.01-10 |
| ZnO and/or | | | |
| TiO₂ | | | |
| CaF₂ | 0-2.8 | 0.001-2.3 | 0.01-2 |

The actual amounts, or proportions by weight, of the aforementioned substances in the ground coat enamel composition according to the invention can in this case be selected within the limits specified in the two tables above depending on the desired cover coat enamel composition and depending on the geometry of the steel base body, with the proportions by weight of silicon dioxide, iron(III) oxide, boron oxide, the sum total of the alkali metal oxides, aluminum oxide and the sum total of the alkaline earth oxides and the substances for adjusting the rheology of the melt of the ground coat enamel composition in each case adding up to 100 percent by weight. The weight figures are in this case based in each case on the dry weight of the ground coat enamel composition according to the invention and not on the weight of the ground coat enamel composition slip in the form of which the ground coat enamel composition is applied to the respective surface of the steel base body.

According to the invention, the ground coat enamel composition is therefore advantageously essentially free from oxides of the elements nickel, cobalt and manganese, which have often been referred to in accordance with the past prior art as “adherence oxides”, and also in particular essentially free from rare earth elements and particularly preferably essentially free from the elements cobalt, nickel, manganese, tungsten, vanadium, niobium, molybdenum, chromium, antimony, arsenic, bismuth, zinc, tin, lead and thallium.

Thus, in an extremely advantageous manner, the ground coat enamel composition according to the invention neither includes toxic heavy metals nor other substances or elements that are undesired or problematic under health or environmentally relevant aspects.

A further advantageous and highly desirable effect of the ground coat enamel composition according to the invention further consists in the easily obtainable and cheap constituents thereof, which are available at all times, require no environmentally harmful mining and are also entirely unproblematic in respect of raw material scarcity, of which there are already signs in the case of several of the metals of adherence oxides used to date.

Furthermore, the object of the invention is also achieved by a ground coat enamel layer applied on a surface of a steel sheet, the former having been produced from a ground coat enamel coating in accordance with the statements above.

The ground coat enamel layer according to the invention at a steel-ground coat enamel contact zone includes iron silicate, which, in the course of a ground coat enameling process and at the temperatures in the range from 890° C. to 950° C. that are required for such a process, has formed from a reaction of the metallic iron of the steel base body with the iron(III) oxide added to the ground coat enamel composition in the presence of silicon dioxide.

This steel-ground coat enamel contact zone extends here from the steel surface in the direction of the ground coat enamel, with the iron silicate in the cooled state, i.e. in the form of a finished ground coat enamel layer, adhering extremely firmly to the surface of the steel base body and forming thereon a solid coat that extends over the entire surface and in this way shields the surface coated with the ground coat enamel from further external effects.

A particular advantage of the ground coat enamel layer according to the invention consists in that the ground coat enamel layer can have a layer thickness in the range from no less than 0.05 mm to no more than 0.8 mm, but preferably in the range from 0.1 mm to 0.4 mm and particularly preferably in the range from 0.1 mm to 0.3 mm.

Since the ground coat enamel layer according to the invention can have such a low layer thickness of much less than half a millimeter, there remains compared to the prior art a considerable margin for application of one or more cover coat enamel layers in order to produce DIN/ISO standard-compliant highly corrosion-resistant coatings. This is the case all the more so given that in accordance with the invention it is not necessary to apply more than one ground coat enamel layer to the steel base body.

An important advantageous point of the invention further resides in the fact that the iron silicate according to the invention is crystalline, especially essentially, i.e. mainly, in the form of fayalite crystals, Fe₂SiO₄. These fayalite crystals have a very high melting point of over 1000° C. and hence withstand even repeated intense heat in further downstream firing processes. The iron silicate forms in the form of fayalite crystals on the steel surface of the steel base body rather a continuous solid, crystalline and extremely resistant layer that for its part has a layer thickness of less than 80 μm, preferably less than 50 μm, for example in the range from 15 μm to 50 μm. It should be further pointed out at this juncture that the iron silicate according to the invention does not necessarily have to be exclusively in the form of fayalite crystals, but instead in the presence of other metals, such as for example magnesium or calcium, may also be in the form of mixed silicates, for example in the form of olivine (Mg,Fe)₂SiO₄ or Hedenbergite (CaFe) (Si₂O₆), if such metals were to be present in the ground coat enamel composition. However, an essential point of the invention consists in any case in that adhesion of the ground coat enamel layer to the steel surface of the base body is achieved by exploiting an Fe—O—Si— bonding structure that is present in iron silicate.

As mentioned above, the iron silicate at the steel-ground coat enamel contact zone forms an, in particular full-surface, crystal layer that is suitable for forming a barrier layer between the steel surface of the base body and, for example, a glassy, or amorphous, phase of the ground coat enamel layer that directly adjoins the fayalite crystal layer and especially and particularly advantageously between the steel surface of the base body and the at least one cover coat enamel layer of a highly corrosion-resistant article produced using the ground coat enamel composition according to the invention. Because of this barrier layer property of the crystal layer, a reaction of components of the steel base body with components of the enamel layer(s) is effectively prevented, with a layer thickness of the crystal layer being in the range from 10 μm to 65 μm, preferably in the range from 15 μm to 50 μm and particularly preferably not more than 50 μm and forming an effective and good protection against reactions such as proceeded in past ground coat enamel coatings known from the prior art.

For this reason, the ground coat enamel layer according to the invention and especially also the crystal layer are essentially bubble-free and especially also essentially carbon monoxide-free and/or carbon dioxide-free, which markedly improves and increases both the chemical and also in particular the mechanical stability of a ground coat enamel layer produced using such a ground coat enamel composition according to the invention, and as a consequence also the chemical and mechanical stability of a highly corrosion-resistant article produced using such a ground coat enamel composition according to the invention compared to past highly corrosion-resistant articles.

Since the crystal layer of the ground coat enamel layer according to the invention offers such a good mutual barrier effect in terms both of material ingress to the steel surface of the base body and of material egress from the steel of the base body, it is possible in accordance with the invention to use a steel base body the steel sheet of which, especially at the steel-ground coat enamel contact zone, has a carbon content in the range from 0% by weight to 0.5% by weight, preferably in the range from 0.01% by weight to 0.45% by weight and particularly preferably in the range from 0.08% by weight to 0.3% by weight.

In an extremely advantageous manner, it is thus possible to use steel which has a very high carbon content compared to past requirements in the production of highly corrosion-resistant articles. Since it is therefore not necessary in accordance with the invention to resort to very low-carbon and often expensive steels, and instead conventional steel grades can be used, the ground coat enamel composition according to the invention also enables a more cost-effective production of highly corrosion-resistant articles.

A further important aspect of the invention consists in that a ground coat enamel layer that has been produced using the ground coat enamel composition according to the invention possesses a self-repair mechanism. The ground coat enamel composition according to the invention thus combines two properties that are extremely useful and important for the production of highly corrosion-resistant articles. The first of these two properties consists in being able to form iron silicate crystals with the metallic iron in the steel base body, these forming, as a high temperature-resistant firmly adhering and full-surface layer, a barrier layer on the surface of the steel base body. The second property of the ground coat enamel composition according to the invention further consists in forming a bonding layer, i.e. providing an adhesion layer, at which an optimal bonding to the cover coat enamel layer can be realized.

Should, in the rather theoretical scenario where the crystal layer firmly adhering to the surface of the steel layer is damaged and for example incurs a hole or a thinned spot, which would theoretically be conceivable for example due to a mechanical action of force, then the aforementioned self-repair mechanism automatically comes into effect since, on damage to the crystal layer, instantaneous and automatic reformation of fayalite crystals takes place at the damaged site in the event of heating since at that location metallic iron(0) again reacts with the iron(III) oxide present in the ground coat enamel composition according to the invention to give iron(II) and then immediately reacts further with silicon dioxide, likewise present in the ground coat enamel composition according to the invention, to give iron silicate. This reaction takes place for as long as the iron silicate crystal layer allows on account of its initially still small layer thickness and ends, likewise automatically, when the layer thickness of the iron silicate crystal layer has reached a maximum layer thickness of approximately 65 μm to 80 μm.

The first growth of the iron silicate crystal layer on the surface of the steel base body also ends in the same way.

The object of the invention is furthermore also achieved by an article that is highly corrosion-resistant with respect to mechanical, thermal and chemical effects, having a ground coat enamel layer applied on a steel sheet and in a form in accordance with the statements above and at least one cover coat enamel layer applied on the ground coat enamel layer.

According to the invention, a total layer thickness of ground coat enamel layer and of the at least one cover coat enamel layer of a highly corrosion-resistant article produced using the ground coat enamel composition according to the invention is in the range from 0.5 mm to 3 mm, preferably in the range from 0.8 mm to 2.6 mm and particularly preferably no more than 2.4 mm. In this way, on account of the extremely thin ground coat enamel layer that can be achieved in accordance with the invention, it is advantageously possible to produce highly corrosion-resistant articles that have enhanced high corrosion resistance compared to conventional highly corrosion-resistant articles with identical enamel layer thickness, since the ground coat enamel layer according to the invention, which need only be present as one layer, allows, or makes it possible, to apply more cover coat enamel layers than before and nevertheless still satisfy the DIN/ISO standard 28721-1.

In addition, the object of the invention is in particular also achieved by a method for producing a ground coat enamel layer having the abovementioned properties, comprising conducting the following steps of:
i. providing a steel sheet;
ii. optionally superficially removing rust, especially loose rust;
iii. applying a ground coat enamel composition in accordance with the statements above;
iv. firing the ground coat enamel composition at a temperature in the range from 890° C. to 950° C., preferably in the range from 900° C. to 940° C. and particularly preferably in the range from 920° C. to 930° C., over a period in the range from 20 min to 80 min, preferably in the range from 25 min to 70 min and particularly preferably in the range from 28 min to 60 min.

In this respect, it should be pointed out at this juncture that a ground coat enamel layer according to the invention can be applied using the ground coat enamel composition according to the invention in principle both on a new steel base body, and yet such an application of a ground coat enamel layer is at any time also possible on a used steel base body, for example in order to reuse a steel base body following damage or wear. In the latter case, all that is needed according to the invention is to remove earlier deficient enamel layers and loose constituents from the steel base body, for example by blasting. Following this, coating anew with the ground coat enamel composition according to the invention can be effected, exploiting all of the associated advantages.

In addition, the object of the invention is further also achieved in particular by a method for producing a highly corrosion-resistant article, in particular newly producing or reconditioning a used highly corrosion-resistant article, comprising conducting the following steps of:
a) providing a new article made from steel sheet or a used highly corrosion-resistant article which in particular has a damaged ground coat enamel layer and/or cover coat enamel layer;
b) cleaning a surface of the article that is to be coated, in particular mechanically by for example blasting with at least one abrasive substance, in order to substantially remove any loose adhesions, such as for example rust, and/or one or more earlier, especially defective, coatings;
c) producing once a ground coat enamel layer on the cleaned steel sheet to be coated in accordance with, or in analogy to, the abovementioned statements concerning a method for producing a ground coat enamel layer;
d) applying a cover coat enamel composition slip for subsequent formation of a cover coat enamel layer on the ground coat enamel layer;
e) drying the cover coat enamel composition slip;
f) heating the article with the ground coat enamel layer and the cover coat enamel composition, or rather the dried cover coat enamel composition slip, to a firing temperature in the range from 780° C. to 870° C., preferably in the range from 800° C. to 860° C. and particularly preferably in the range from 800° C. to 840° C.;
g) maintaining the firing temperature for a period in the range from 6 min to 125 min, preferably in the range from 6.75 min to 100 min, and particularly preferably in the range from 7.5 min to 90 min, to produce the cover coat enamel layer;
h) cooling the article in a controlled manner;
i) if required, repeatedly applying a cover coat enamel composition slip for subsequent formation of a further cover coat enamel layer on the preceding cover coat enamel layer analogously to the five preceding steps d) to h).

The method according to the invention for producing a highly corrosion-resistant article thus exhibits numerous advantages, grounded firstly in the fact that even with geometrically difficult-to-coat articles a single coating with the ground coat enamel composition is sufficient since the crystal layer acting as barrier layer forms at all points on the article so long as the crystal layer has not reached a thickness that would end a reaction of the metallic iron from the steel base body with the iron(III) oxide and the silicon dioxide from the ground coat enamel composition. Since the thickness of the crystal layer, measured on the geometries of typical steel base bodies, is very thin, i.e. generally less than 50 μm, it is not necessary in accordance with the invention to apply the ground coat enamel composition according to the invention with a uniform layer thickness at all locations on the article to be coated since, in particular at the high temperatures required for the coating, there is in any case sufficient migration of the reaction components to thin spots and/or defects at which the layer thickness of the crystal layer has possibly not yet grown sufficiently thick. Such a thin spot and/or defect is thus virtually automatically repaired and/or supplemented by dint of the ground coat enamel composition according to the invention until a sufficient layer thickness of the crystal layer has been reached. Since, according to the invention, in addition to the iron(0) originating from the steel surface of the steel base body, both iron(III) oxide and silicon dioxide are present in excess in the ground coat enamel composition according to the invention, there is in any case always enough iron(0), iron(III) oxide and silicon dioxide present to enable a full-surface and dense formation of the crystal layer of fayalite crystals. According to the invention, this fact also contributes to the extremely advantageous self-repair mechanism of the fayalite crystal layer.

A further advantage of the method according to the invention for producing a highly corrosion-resistant article further also consists in that the barrier layer of fayalite crystals protecting the steel of the steel base body is very thin and thus also enables a very thin ground coat enamel layer, meaning that it is possible to apply more cover coat enamel layers on the ground coat enamel layer than had been possible to date. This firstly enables a more pronounced high corrosion resistance and also a greater mechanical stability of the highly corrosion-resistant article produced by the method according to the invention.

Furthermore, the object of the invention is in particular also achieved by the use of a ground coat enamel composition in accordance with the statements above for producing a highly corrosion-resistant article as described above.

The core of the invention and the advantages thereof can be summarized as follows.

The essential core of the invention consists in that a completely new approach for ground coat enamel adhesion is provided.

Thus, in order to overcome the difficulties known from the prior art for the production of ground coat enamel layers on the one hand and for the production of highly corrosion-resistant articles on the other hand and also to reduce the amount of past adherence oxides at least, in particular to zero, a new adhesion mechanism is provided.

The approach according to the invention completely avoids the use of all metal oxides described to date for the above-described formation of an alloy between adherence oxides and steel, this having been necessary hitherto for formation of chemically stable adhesion of enamel on steel.

The new adhesion mechanism according to the invention uses Fe₂O₃ as bonding substance for the production of a chemical bond of the ground coat enamel layer with the steel.

Thus, when adding Fe₂O₃ to an enamel without adherence oxides, in a reaction with the steel sheet at the enamel-steel interface, there is a redox reaction between the Fe₂O₃ of the enamel layer and the metallic iron (Fe⁰). Fe³⁺ from the enamel layer is converted to Fe²⁺ and at the same time iron Fe⁰ from the steel surface is oxidized to Fe²⁺. A local oversaturation with Fe²⁺ arises along the interfacial layer, and the former immediately further reacts with SiO₂ and forms iron silicate. Since the liquid glass melt is now oversaturated with Fe²⁺, iron silicate crystals crystallize out along the interfacial layer with the steel—and do so only here. In order to make possible this oversaturation, according to the invention a percentage proportion by weight of iron(III) oxide in the range from five percent by weight to 28 percent by weight is used, so that there is always a sufficient amount of Fe₂O₃ present in the ground coat enamel composition according to the invention. Such a content of Fe₂O₃ is ideal so that the enamel melt reacts with the steel to form a crystal layer as early as during a first firing run, i.e. during a first and only firing run for forming the ground coat enameling. The duration of the firing run depends here on the thickness of the steel sheet and according to the invention is in a period within the range from 20 minutes to 80 minutes, the time required for firing the ground coat enamel layer increasing with the layer thickness of the steel sheet. In this respect, it is pointed out that the period of 20 minutes to 80 minutes relates to how long the temperature required for firing the ground coat enamel layer is maintained after the firing temperature has been reached.

In the course of this first firing run, a continuous layer of high-melting iron silicate crystals, namely essentially in the form of fayalite, i.e. Fe₂SiO₄, forms along the enamel melt-steel interface on account of the Fe₂O₃ and SiO₂ present in the enamel melt. The crystals forming have a melting point that is higher than 1000° C.; they thus form a continuous solid and crystalline layer that does not break down again even in subsequent firing processes. The crystal layer thus effectively blocks further reaction of the enamel melt with the steel. Depending on the applied layer thickness of the ground coat enamel, the crystal layer particularly preferably has a layer thickness of from 15 μm to 50 μm. By the time a continuous crystal layer has formed along the steel-enamel interface, crystal growth also automatically halts itself. Thus, even in long additional firing runs, no further growth of the crystal layer along the interfacial layer takes place.

Since the crystal layer remains very thin, it requires fairly little enamel to form it. Even a normally inadequate and excessively thin application of the ground coat enamel composition according to the invention to the steel surface, which with past ground coat enamels would have led to an inadequate formation of the ground coat enamel-adhesion layer and hence would have either necessitated a second ground coat application run or even led to the scaling-off or flaking-off of the enamel layer, allows the application of cover coat enamel when using the ground coat enamel composition according to the invention. Even for the case where the ground coat enamel composition itself does not provide a sufficient amount of silicon dioxide, this does not result in the ground coat enamel layer according to the invention being insufficient or unusable, since in this case the subsequently applied cover coat enamel would provide the required amount of SiO₂ to enable crystallization and the formation of iron silicate crystals. As already mentioned above, this effect is also essential for the extremely advantageous self-repair mechanism of the ground coat enamel layer according to the invention.

The reduction reaction of Fe₂O₃ to Fe²⁺ and the oxidation of metallic Fe⁰ to Fe²⁺ and also the further reaction with SiO₂ and the crystallization of the iron silicate are exothermic processes that facilitate the chemical adhesion. An extremely stable and firm bonding via Fe—O—Si— is formed.

Since there are incidentally no differences in respect of the electronegativities of the metals of the adherence oxides used to date and the steel substrate of the base body, it is also not possible for there to be an uncontrollable further reaction in the sense of an alloy formation and/or redox reaction along the steel-enamel interfacial layer and/or the adhesion layer. When the crystal layer has completely formed, the crystal formation reaction stops automatically. The driving force behind the adhesion reaction is the formation of the crystal layer. The ground coat enamel as a result is markedly more resistant with respect to long firing temperatures and firing times than the ground coat enamels known to date according to the prior art that function using adherence oxides.

A further essential advantage of the ground coat enamel composition according to the invention further consists in that there is a reduced production of CO₂ and CO bubbles in the ground coat enamel, since the solidified iron silicate crystals prevent further reaction of the steel surface.

The advantages of the invention therefore emerge as follows:
It is possible to dispense with the hitherto conventional and problematic adherence oxides cobalt oxide, manganese oxide, nickel oxide for the formation of a chemically stable adhesion of enamel on steel.
It is possible to dispense with rare earth oxides for the formation of a chemically stable adhesion of enamel on steel.
It is possible to dispense with other, especially toxic, heavy metal oxides such as molybdenum (Mo), vanadium (V) and/or tungsten (W) for the formation of a chemically stable adhesion of enamel on steel.
A reduction in the minimum layer thickness of the ground coat enamel layer to less than 0.1 mm is possible.
It is possible to dispense with a second ground coat enamel layer application.
A reduction in the ground coat enamel layer thickness required for adhesion to approx. 0.1 mm to 0.3 mm is possible.
The ground coat enamel layer possesses an inherent self-repair function, inter alia even in the case of inadequate ground coat enamel application.
The crystal layer forms an oxidation protection for the steel already during the ground coat enameling process.
On reaching a sufficient layer thickness, the growth of the crystals drastically and automatically slows.
The layer thickness of the crystal layer along the steel surface does not exceed a 50 μm thickness under usual conditions.
It is possible to dispense with an annealing run when using steel sheets having a carbon content higher than 0.14% by weight.
Direct use of steel sheets having a relatively high carbon content of up to 0.25% by weight, possibly even up to 0.5% by weight, is possible.
The ground coat enamel according to the invention does not include any adherence oxides, any rare earth metals or any toxic heavy metals, especially none of the following elements Co, Ni, Mn, W, V, Nb, Mo, Cr, Sb, As, Bi, Pb, Tl.
The adhesion reaction of the ground coat enamel layer to the steel surface proceeds via a crystallization process with an Fe—O—Si— bond.
No alloy formation with more noble partners, or metals (Co, Ni, Mn, W, V, Nb, Mo, Cr, Sb, As, Bi, Pb, Tl), takes place along the steel interface; such an alloy formation as necessary according to the past prior art for producing the adhesion is not required according to the invention.

Further embodiments of the invention emerge from the dependent claims.

The invention shall be described hereinafter with reference to an exemplary embodiment that is elucidated in more detail on the basis of the drawing. In the drawing:

FIG. 1 shows a sectional view through a conventional highly corrosion-resistant article according to the prior art; and

FIG. 2 shows a sectional view through a highly corrosion-resistant article produced according to the invention.

In the following description, the same reference signs are used for identical and identically acting parts.

FIG. 1 shows a sectional view through a conventional highly corrosion-resistant article 10. The article 10 consists of a steel sheet 20, to which a ground coat enamel layer 30 has been applied. The ground coat enamel layer 30 adjoins the steel sheet 20 along a steel-ground coat enamel contact zone 60, where along the contact zone 60 a layer of iron oxide dissolved in the ground coat enamel has formed, which is adjoined by a heavily bubble 50-laden glassy ground coat enamel layer 30. Arranged above the ground coat enamel layer 30 are a plurality of likewise bubble-rich cover coat enamel layers 40.

FIG. 2 shows a sectional view through a highly corrosion-resistant article 10 that has been produced in accordance with the invention using a ground coat enamel composition according to the invention. The article 10 produced according to the invention thus comprises a steel layer in the form of a steel sheet 20, on which a ground coat enamel layer 30 has been applied. The ground coat enamel layer 30 for its part has, along a steel-ground coat enamel contact zone 60, a crystal layer 35 which covers the steel sheet 20 over the full surface and shields it with respect to effects from the overlying ground coat enamel layer 30 and also from a cover coat enamel layer 40 lying yet further above. The crystal layer 35 consists of fayalite crystals and is bubble-free. The thickness of the crystal layer 35 is essentially 50 μm. It can readily be seen from FIG. 2 that any bubbles present are so only in a region of the ground coat enamel layer 30 that adjoins the cover coat enamel layer 40, and the ground coat enamel layer 30 is otherwise bubble-free. Further bubble formation does not take place; instead, the region of the ground coat enamel layer adjoining the crystal layer 35 is also bubble-free.

Exemplary formulations for a glass composition according to the invention are given in tables below.

| | Formula- | Formula- | Formula- | Formula- | Formula- |
|---|---|---|---|---|---|
| | tion 1 | tion 2 | tion 3 | tion 4 | tion 5 |
| Constit- | % by | % by | % by | % by | % by |
| uents | weight | weight | weight | weight | weight |
| SiO₂ | 56.7 | 56.8 | 57.3 | 57.9 | 59.6 |
| Na₂O | 9.4 | 8.1 | 10.1 | 8.8 | 10.4 |
| K₂O | 3.1 | 1.3 | 2.7 | 1.8 | 2.1 |
| Li₂O | 0.4 | 0 | 0.4 | 1.3 | 1.6 |
| B₂O₃ | 8.1 | 9.3 | 8.7 | 9.3 | 6.5 |
| MgO | 1.3 | 0.1 | 1.1 | 0.8 | 0.7 |
| CaO | 0.4 | 0.6 | 0.6 | 0.6 | 0.4 |
| SrO | 0.3 | 0 | 0 | 0.1 | 0.1 |
| BaO | 1.1 | 2 | 1.4 | 0.3 | 0 |
| Fe₂O₃ | 13.2 | 14.8 | 11.3 | 13.8 | 13.1 |
| Al₂O₃ | 5.2 | 6.7 | 5.8 | 4.7 | 5.1 |
| TiO₂ | 0.4 | 0.1 | 0.3 | 0.4 | 0.1 |
| CaF₂ | 0.4 | 0.2 | 0.3 | 0.2 | 0.3 |
| Sum total | 100 | 100 | 100 | 100 | 100 |

| | Formula- | Formula- | Formula- | Formula- |
|---|---|---|---|---|
| | tion 6 | tion 7 | tion 8 | tion 9 |
| Constit- | % by | % by | % by | % by |
| uents | weight | weight | weight | weight |
| SiO₂ | 60.4 | 65.2 | 65.9 | 66.3 |
| Na₂O | 8.3 | 9.5 | 8.5 | 9.6 |
| K₂O | 2.6 | 1.8 | 1.7 | 1.1 |
| Li₂O | 0 | 0 | 0 | 0.2 |
| B₂O₃ | 8.8 | 6.7 | 6.5 | 8.3 |
| MgO | 0 | 0.2 | 0.5 | 1.3 |
| CaO | 2.7 | 0.4 | 0.3 | 0.4 |
| SrO | 0 | 0 | 0.2 | 0 |
| BaO | 0 | 0 | 0.2 | 0.2 |
| Fe₂O₃ | 10.1 | 12.8 | 11.9 | 8.1 |
| Al₂O₃ | 7.1 | 3 | 3.9 | 4.3 |
| TiO₂ | 0 | 0 | 0.2 | 0.1 |
| CaF₂ | 0 | 0.4 | 0.2 | 0.1 |
| Sum total | 100 | 100 | 100 | 100 |

It should be pointed out at this juncture that all parts described above taken alone and in any combination, especially the details illustrated in the drawings, are claimed as essential to the invention. Modifications thereof are familiar to those skilled in the art.

### LIST OF REFERENCE SIGNS

10 highly corrosion-resistant article (detail)
20 steel sheet
30 ground coat enamel layer
35 crystal layer
40 cover coat enamel layer
50 bubbles
60 steel-ground coat enamel contact zone

1. A ground coat enamel composition for production of an adhesion promoter layer between steel and at least one cover coat enamel for production of an enamel-based coating that is highly corrosion-resistant with respect to mechanical, thermal and chemical effects, wherein the ground coat enamel composition includes boron oxide (B₂O₃) and alkali metal oxide(s), especially Li₂O, Na₂O and/or K₂O, in proportions by weight in accordance with the following table:

| Constituent | [% by weight] |
|---|---|
| B₂O₃ | 4-22 |
| Sum total of alkali | 7.8-22.5 |
| metal oxide(s) | |

and, as a first main constituent, SiO₂ with a percentage proportion by weight in the range from 35% by weight to 70% by weight, and, as a second main constituent, Fe₂O₃ with a percentage proportion by weight in the range from 5% by weight to 28% by weight.

2. The ground coat enamel composition as claimed in claim 1, wherein the ground coat enamel composition further includes Al₂O₃ and alkaline earth metal oxide(s), especially calcium oxide, in proportions by weight in accordance with the following table:

| Constituent | [% by weight] |
|---|---|
| Al₂O₃ | 1.5-13 |
| Sum total of alkaline | 0.25-6 |
| earth metal oxide(s) | |

3. The ground coat enamel composition as claimed in claim 2, wherein the ground coat enamel composition further includes at least one substance, especially ZnO, TiO₂ and/or CaF₂, for controlling a rheology of a melt of the ground coat enamel composition, in proportions by weight in accordance with the following table:

| Constituent | [% by weight] |
|---|---|
| Sum total of | 0-14 |
| ZnO and/or | |
| TiO₂ | |
| CaF₂ | 0-2.8 |

4. The ground coat enamel composition as claimed in claim 1, wherein the ground coat enamel composition is essentially free from adherence oxides, namely oxides of the elements nickel, cobalt and manganese, and also in particular essentially free from rare earth elements.

5. A ground coat enamel layer applied on a steel sheet, wherein the ground coat enamel layer has been produced from a ground coat enamel coating as claimed in claim 1.

6. The ground coat enamel layer as claimed in claim 5, wherein a steel-ground coat enamel contact zone includes iron silicate.

7. The ground coat enamel layer as claimed in claim 5, wherein the ground coat enamel layer has a layer thickness in the range from 0.05 mm to 0.8 mm.

8. The ground coat enamel layer as claimed in claim 6, wherein the iron silicate is crystalline, especially essentially in the form of fayalite crystals, Fe₂SiO₄.

9. The ground coat enamel layer as claimed in claim 6, wherein the iron silicate at the steel-ground coat enamel contact zone forms.

10. The ground coat enamel layer as claimed in claim 9, wherein a layer thickness of the crystal layer is in the range from 10 μm to 65 μm.

11. The ground coat enamel layer as claimed in claim 5, wherein the ground coat enamel layer, especially the crystal layer, is essentially bubble-free and especially CO— and/or CO₂-free.

12. The ground coat enamel layer as claimed in claim 5, wherein the steel sheet, especially at the steel-ground coat enamel contact zone, has a carbon content in the range from 0% by weight to 0.5% by weight.

13. An article that is highly corrosion-resistant with respect to mechanical, thermal and chemical effects, having a ground coat enamel layer as claimed in claim 5 applied on a steel sheet and at least one cover coat enamel layer applied on the ground coat enamel layer.

14. The highly corrosion-resistant article as claimed in claim 13, wherein a total layer thickness of ground coat enamel layer and of the at least one cover coat enamel layer is in the range from 0.5 mm to 3 mm.

15. A method for producing a ground coat enamel layer by the following steps of:
i. providing a steel sheet;
ii. optionally superficially removing rust, especially loose rust;
iii. applying a ground coat enamel composition as claimed in claim 1;
iv. firing the ground coat enamel composition at a temperature in the range from 890° C. to 950° C., over a period in the range from 20 min to 80 min.

16. A method for producing a highly corrosion-resistant article, in particular newly producing or reconditioning a used highly corrosion-resistant article, as claimed in claim 13,
characterized by
the following steps of:
a) providing a new article made from steel sheet or a used highly corrosion-resistant article which in particular has a damaged ground coat enamel layer and/or cover coat enamel layer;
b) cleaning a surface of the article that is to be coated, in particular mechanically by for example blasting with at least one abrasive substance, in order to substantially remove any loose adhesions, such as for example rust, and/or one or more earlier, especially defective, coatings;
c) once producing a ground coat enamel layer on the cleaned steel sheet to be coated in accordance with, or in analogy to, claim 15;
d) applying a cover coat enamel composition slip for subsequent formation of a cover coat enamel layer on the ground coat enamel layer;
e) drying the cover coat enamel composition slip;
f) heating the article with the ground coat enamel layer and the cover coat enamel composition, or rather the dried cover coat enamel composition slip, to a firing temperature in the range from 780° C. to 870° C.;
g) maintaining the firing temperature for a period in the range from 6 min to 125 min;
h) cooling the article in a controlled manner;
i) if required, repeatedly applying a cover coat enamel composition slip for subsequent formation of a further cover coat enamel layer on the preceding cover coat enamel layer.

17. (canceled)

18. A ground coat enamel composition for production of an adhesion promoter layer between steel and at least one cover coat enamel for production of an enamel-based coating that is highly corrosion-resistant with respect to mechanical, thermal and chemical effects, wherein the ground coat enamel composition includes boron oxide (B₂O₃) and alkali metal oxide(s), especially Li₂O, Na₂O and/or K₂O, in proportions by weight in accordance with the following table:

| Constituent | [% by weight] |
|---|---|
| B₂O₃ | 4.5-21.5 |
| Sum total of alkali | 8.5-21.5 |
| metal oxide(s) | |

and, as a first main constituent, SiO₂ with a percentage proportion by weight in the range from 35% by weight to 70% by weight and as a second main constituent, Fe₂O₃ with a percentage proportion by weight in the range from 5% by weight to 28% by weight.

19. The ground coat enamel composition as claimed in claim 1, wherein the ground coat enamel composition further includes Al₂O₃ and alkaline earth metal oxide(s), especially calcium oxide, in proportions by weight in accordance with the following table:

| Constituent | [% by weight] |
|---|---|
| Al₂O₃ | 2-12 |
| Sum total of alkaline | 0.4-5 |
| earth metal oxide(s) | |

20. The ground coat enamel composition as claimed in claim 2, wherein the ground coat enamel composition further includes at least one substance, especially ZnO, TiO₂ and/or CaF₂, for controlling a rheology of a melt of the ground coat enamel composition, in proportions by weight in accordance with the following table:

| Constituent | [% by weight] |
|---|---|
| Sum total of | 0.001-12 |
| ZnO and/or | |
| TiO₂ | |
| CaF₂ | 0.001-2.3 |
